(19) United States
(12) Patent Application Publication
(10) Pub. No.: US 2026/0204009 A1
(43) Pub. Date: Jul. 16, 2026

(54) WEARABLE DEVICE WITH DISPLAY, AND METHOD THEREFOR

(71) Applicants: Samsung Electronics Co., Ltd., Suwon-si (KR); UNIVERSITY-INDUSTRY COOPERATION GROUP OF KYUNG HEE UNIVERSITY, Yongin-si (KR)

(72) Inventors: Chanhyung YOO, Suwon-si (KR); Seungwoo LEE, Yongin-si (KR); Wonbeen JEONG, Yongin-si (KR); Jeongsoo PARK, Yongin-si (KR); Nari KIM, Suwon-si (KR); Kyongtae PARK, Suwon-si (KR); Hoyoung JUNG, Suwon-si (KR)

(21) Appl. No.: 19/563,444

(22) Filed: Mar. 11, 2026

Related U.S. Application Data
(63) Continuation of application No. PCT/KR2024/010812, filed on Jul. 25, 2024.

(30) Foreign Application Priority Data
Sep. 14, 2023 (KR) 10-2023-0122518
Oct. 19, 2023 (KR) 10-2023-0140693

(51) Int. Cl. G06T 15/50; G02B 27/01; G06F 3/01

(52) U.S. Cl. CPC G06T 15/506; G02B 27/017; G06F 3/013

(57) ABSTRACT

A wearable device is provided. The wearable device includes memory, comprising one or more storage media, storing instructions, eye tracking circuitry configured to obtain eye tracking data regarding a gaze of one or more eyes, a display, and at least one processor including processing circuitry, wherein the instructions, when executed by the at least one processor individually or collectively, cause the wearable device to determine, based on of the eye tracking data, a foveated area of a screen displayed on the display and a peripheral area of the screen encompassing the foveated area, while the screen is displayed on the display operating in a first state, control a luminance of the peripheral area to display the peripheral area dimmer than the foveated area, and while the screen is displayed on the display operating as a second state for lower power consumption than the first state, control the luminance of the peripheral area to display the peripheral area dimmer than the peripheral area displayed on the display operating in the first state.

### CROSS-REFERENCE TO RELATED APPLICATION(S)

This application is a continuation application, claiming priority under 35 U.S.C. § 365(c), of an International application No. PCT/KR 2024/010812, filed on Jul. 25, 2024, which is based on and claims the benefit of a Korean patent application number 10-10-2023-0122518, filed on Sep. 14, 2023, in the Korean Intellectual Property Office, and of a Korean patent application number 10-2023-0140693, filed on Oct. 19, 2023, in the Korean Intellectual Property Office, the disclosure of each of which is incorporated by reference herein in its entirety.

### JOINT RESEARCH AGREEMENT

The disclosure was made by or on behalf of the below listed parties to a joint research agreement. The joint research agreement was in effect on or before the date the disclosure was made and the disclosure was made as a result of activities undertaken within the scope of the joint research agreement. The parties to the joint research agreement are 1) SAMSUNG ELECTRONICS CO., LTD. and 2) UNIVERSITY-INDUSTRY COOPERATION GROUP OF KYUNG HEE UNIVERSITY.

### BACKGROUND

### 1. Field

The disclosure relates to a wearable device with a display and a method thereof.

### 2. Description of Related Art

A wearable device may be used to provide an augmented reality (AR) service, a virtual reality (VR) service, a mixed reality (MR) service, or an extended reality (XR) service. For example, the wearable device may include a display located relatively close in front of a user's eyes. The display may be used to display an image.

The above information is presented as background information only to assist with an understanding of the disclosure. No determination has been made, and no assertion is made, as to whether any of the above might be applicable as a prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable device with a display and a method thereof.

Additional aspects will be set forth in part in the description which follows and, in part, will be apparent from the description, or may be learned by practice of the presented embodiments.

In accordance with an aspect of the disclosure, a wearable device is provided. The wearable device includes memory, comprising one or more storage media, storing instructions, eye tracking circuitry configured to obtain eye tracking data regarding a gaze of one or more eyes, a display, and at least one processor including processing circuitry, wherein the instructions, when executed by the at least one processor individually or collectively, cause the wearable device to determine, based on the eye tracking data, a foveated area of a screen displayed on the display and a peripheral area of the screen that surrounds the foveated area, while the screen is displayed on the display operating as a first state, control a luminance of the peripheral area to display the peripheral area dimmer than the foveated area, and while the screen is displayed on the display operating as a second state for lower power consumption than the first state, control the luminance of the peripheral area to display the peripheral area dimmer than the peripheral area displayed on the display operating as the first state.

In accordance with another aspect of the disclosure, a method is provided. The method is executed by a wearable device with eye tracking circuitry configured to obtain eye tracking data regarding gaze of one or more eyes and a display. The method includes determining, based on the eye tracking data, a foveated area of a screen displayed on the display and a peripheral area of the screen that surrounds the foveated area. The method includes, while the screen is displayed on the display operating as a first state, controlling luminance of the peripheral area to display the peripheral area dimmer than the foveated area. The method includes, while the screen is displayed on the display operating as a second state for lower power consumption than the first state, controlling luminance of the peripheral area to display the peripheral area dimmer than the peripheral area displayed on the display operating as the first state.

In accordance with another aspect of the disclosure, one or more non-transitory computer-readable storage media storing one or more computer programs including computer-executable instructions that, when executed by one or more processors of a wearable device with eye tracking circuitry configured to obtain eye tracking data regarding gaze of one or more eyes and a display individually or collectively, cause the wearable device to determine, based on the eye tracking data, a foveated area of a screen displayed on the display and a peripheral area of the screen that surrounds the foveated area. The one or more programs includes instructions that, when executed by the wearable device, cause the wearable device to, while the screen is displayed on the display operating as a first state, control luminance of the peripheral area to display the peripheral area dimmer than the foveated area. The one or more programs includes instructions that, when executed by the wearable device, cause the wearable device to, while the screen is displayed on the display operating as a second state for lower power consumption than the first state, control luminance of the peripheral area to display the peripheral area dimmer than the peripheral area displayed on the display operating as the first state.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wearable device according to an embodiment of the disclosure;

FIG. 2 is a simplified block diagram of a wearable device according to an embodiment of the disclosure;

FIG. 3 illustrates a first state of a display according to an embodiment of the disclosure;

FIG. 4 illustrates a second state of a display according to an embodiment of the disclosure;

FIG. 5 illustrates a third state of a display according to an embodiment of the disclosure;

FIG. 6 illustrates a method of changing a state of a display from a first state to a second state according to an embodiment of the disclosure;

FIG. 7 illustrates a method of changing a first state changed from a third state to a second state according to an embodiment of the disclosure;

FIG. 8 illustrates n method of changing a state of a display from a first state to a third state, in response to a change of a software application providing frame images used for displaying a screen according to an embodiment of the disclosure;

FIG. 9 is a block diagram of an electronic device in a network environment according to an embodiment of the disclosure; and

FIG. 10 is a block diagram of a display module according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

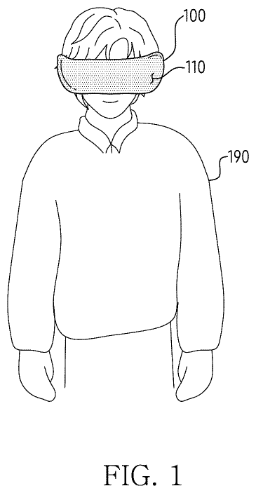

FIG. 1 illustrates a wearable device according to an embodiment of the disclosure.

Referring to FIG. 1, a wearable device 100 may be worn by a user 190. For example, the user 190 may mount the wearable device 100 on a head of the user 190.

The wearable device 100 may include a display 110. For example, the display 110 may be used to display an image, a screen, visual information, visual data, and/or image content. For example, the display 110 may be located in front of one or more eyes of the user 190 wearing the wearable device 100. For example, the wearable device 100 may include the display 110 arranged with respect to one or more eyes of the user 190 when the wearable device 100 is worn by the user 190.

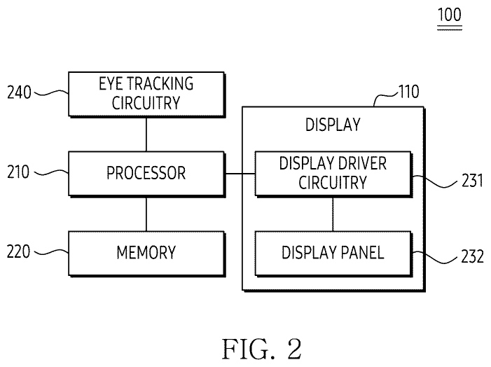

Although not illustrated in FIG. 1, the wearable device 100 may include a rechargeable battery. As a non-limiting example, since the wearable device 100 is a device mounted on a head of the user 190, the rechargeable battery may have a relatively light weight. For example, since the rechargeable battery has a relatively light weight, a capacity of the rechargeable battery may be relatively small. For example, since the capacity of the rechargeable battery may be relatively small, the wearable device 100 may be configured to execute operations for lower power consumption of the display 110. For example, the wearable device 100 may include components for the operations. The components will be exemplified in a description of FIG. 2.

FIG. 1 illustrates the wearable device 100 that is a video see through (or a visual see through) (VST) device, but this is merely exemplary. The wearable device 100 may be implemented as augmented reality (AR) glasses.

FIG. 2 is a simplified block diagram of a wearable device according to an embodiment of the disclosure.

Referring to FIG. 2, a wearable device 100 may include a processor 210, memory 220, and a display 110. The wearable device 100 may further include eye tracking circuitry 240.

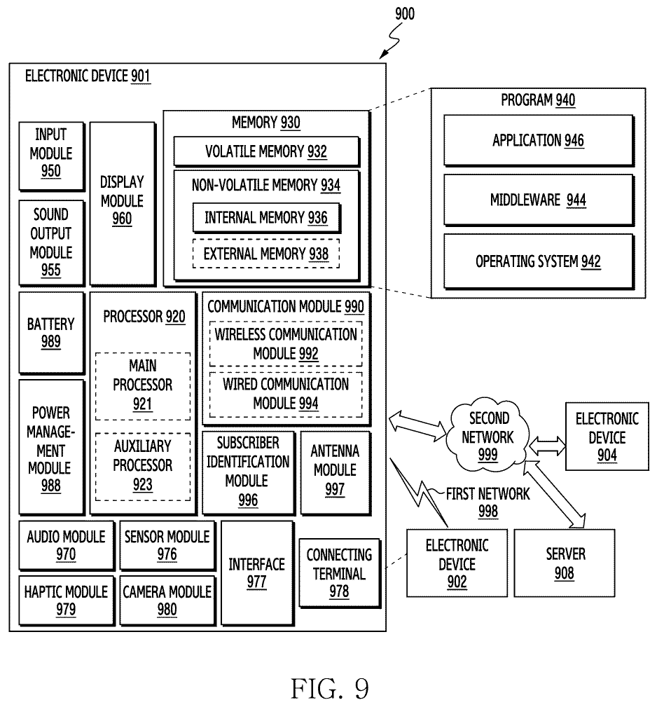

The processor 210 may include at least a portion of a processor 920 of FIG. 9 or correspond to at least a portion of the processor 920 of FIG. 9. The processor 210 may be used to control the memory 220 and the display 120. The processor 210 may be used to control the eye tracking circuitry 240. For example, the processor 210 may include processing circuitry. For example, the processor 210 may include one or more processors or at least one processor. For example, the processor 210 may be configured to cause the wearable device 100 to (individually or collectively) execute at least a portion of operations exemplified in descriptions of FIGS. 2 to 8.

The memory 220 may include at least a portion of memory 930 of FIG. 9 or correspond to at least a portion of the memory 930 of FIG. 9. The memory 220 may be configured to store instructions causing the wearable device 100 to execute at least a portion of operations exemplified in descriptions of FIGS. 2 to 8.

The memory 220 may include one or more memories (or one or more storage media). For example, the memory 220 may include a non-volatile memory (e.g., a non-volatile memory 934 of FIG. 9). As a non-limiting example, the memory 220 may further include a volatile memory (e.g., a volatile memory 932 of FIG. 9).

The memory 220 may store instructions executable by the processor 210. The instructions may, when executed by the processor 210, cause the wearable device 100 to perform operations exemplified in descriptions of FIGS. 2 to 8.

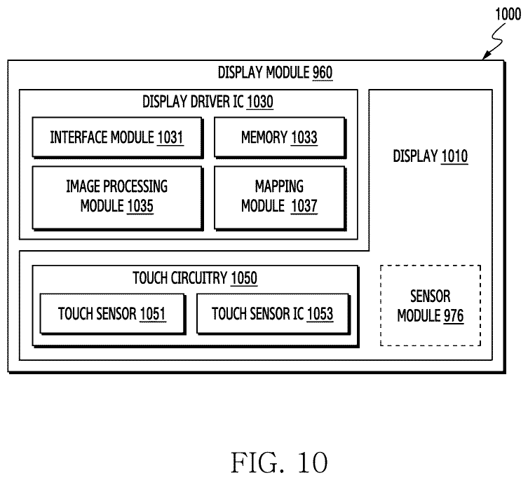

The display 110 may include at least a portion of a display module 960 of FIGS. 9 and 10 or correspond to at least a portion of the display module 960 of FIGS. 9 and 10. The display 110 may be used to display a screen (e.g., visual information, visual data, an image, and/or image content). The display 110 may be used to display the screen obtained (or generated) (or rendered) by the processor 210. For example, the display 110 may be used to display the screen provided from the processor 210.

The display 110 may include display driver circuitry 231 and a display panel 232. For example, the display driver circuitry 231 may be used to display a screen on the display panel 232.

As a non-limiting example, the display driver circuitry 231 may include memory (e.g., a graphic random access memory (GRAM)) configured to store information regarding at least a portion of the screen. As a non-limiting example, the display driver circuitry 231 may not include the memory.

As a non-limiting example, at least a portion of operations of the processor 210 exemplified below may be executed by the display driver circuitry 231. For example, at least a portion of the operations of the processor 210 exemplified below may be replaced with operations of the display driver circuitry 231.

The eye tracking circuitry 240 may be configured to obtain eye tracking data regarding gaze of one or more eyes of a user (e.g., the user 190 of FIG. 1) wearing the wearable device 100. As a non-limiting example, the eye tracking circuitry 240 may include at least one camera facing one or more eyes of the user wearing the wearable device 100. As a non-limiting example, the eye tracking circuitry 240 may include a light emitter (or light emitting circuit) configured to emit light (e.g., infrared light) toward (or to) one or more eyes of the user wearing the wearable device 100. For example, the eye tracking circuitry 240 may obtain, as the eye tracking data, at least a portion of images captured using the at least one camera while the light is emitted from the light emitter, according to a control of the processor 210. For example, the eye tracking data may be provided to the processor 210. As a non-limiting example, the eye tracking data may be used to measure, identify, determine, specify, monitor, or obtain a position of the gaze. As a non-limiting example, the eye tracking data may be used to measure, identify, determine, specify, monitor, or obtain a number of blinks of one or more eyes of the user. As a non-limiting example, the eye tracking data may be used to measure, identify, determine, specify, monitor, or obtain a rate (or speed) of movement of the gaze. As a non-limiting example, the eye tracking data may be used to measure, identify, determine, specify, monitor, or obtain a size of pupil of one or more eyes of the user.

For example, the display 110 may have a plurality of states.

For example, the plurality of states may include a first state. The first state may be defined in the wearable device 100 for lower power consumption. For example, the display 110 may operate as the first state for lower power consumption. The first state may be referred to as a critical condition mode.

For example, the plurality of states may further include a second state. The second state may be defined in the wearable device 100 for lower power consumption. For example, the second state may be defined in the wearable device 100 for lower power consumption than the first state. For example, power consumed by the display 110 operating as the second state may be (generally) smaller than power consumed by the display 110 operating as the first state. However, it is not limited thereto. For example, although the second state is defined for lower power consumption than the first state, the power consumed by the display 110 operating as the second state may not always be smaller than the power consumed by the display 110 operating as the first state. For example, it should be noted that a time interval (or a moment) in which the power consumed by the display 110 operating as the second state is larger than the power consumed by the display 110 operating as the first state may exist according to a state of a screen displayed on the display 110. For example, visual quality of a screen displayed on the display 110 operating as the second state may be lower than visual quality of a screen displayed on the display 110 operating as the first state. The second state may be referred to as a limit condition mode.

For example, the plurality of states may further include a third state. The third state may be defined in the wearable device 100 for performance, unlike the first state and the second state. For example, visual quality of a screen displayed on the display 110 operating as the third state may be higher than visual quality of a screen displayed on the display 110 operating as the first state. For example, visual quality of a screen displayed on the display 110 operating as the third state may be higher than visual quality of a screen displayed on the display 110 operating as the second state. The third state may be referred to as a normal mode.

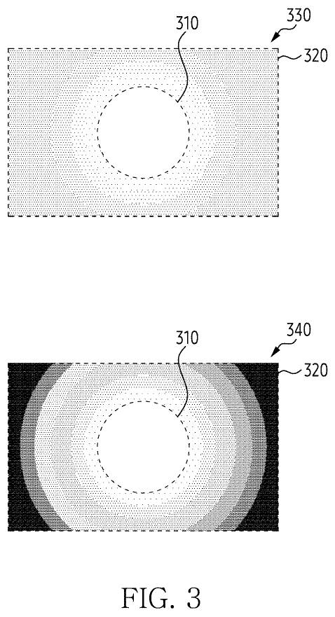

The first state, the second state, and the third state are exemplified in the description of FIGS. 3 to 5.

FIG. 3 illustrates a first state of a display according to an embodiment of the disclosure.

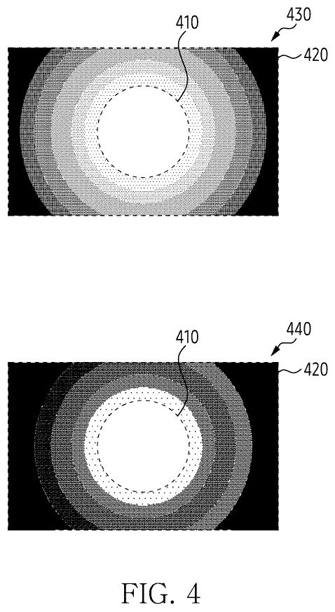

FIG. 4 illustrates a second state of a display according to an embodiment of the disclosure.

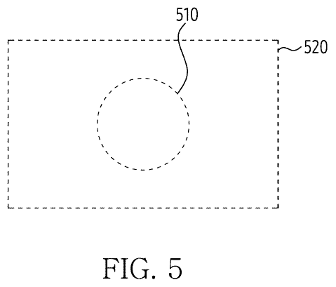

FIG. 5 illustrates a third state of a display according to an embodiment of the disclosure.

Referring to FIG. 3, the processor 210 may determine a foveated area 310 of a screen and a peripheral area 320 of the screen to control luminance of the display 110 operating as the first state.

For example, the foveated area 310 may indicate an area recognized or gazed by fovea centralis vision. For example, the foveated area 310 may be determined based on eye tracking data regarding gaze of one or more eyes of a user (e.g., the user 190) wearing the wearable device 100. For example, the foveated area 310 may indicate a portion of a screen in which the gaze corresponding to the fovea centralis vision is located. For example, the foveated area 310 may indicate a portion of a screen focused by a user viewing the screen. For example, the foveated area 310 may be circular as illustrated in FIG. 3. For example, the foveated area 310 may be rectangular or triangular, unlike the illustration of FIG. 3. However, it is not limited thereto. For example, the foveated area 310 may have a shape corresponding to a shape of an area recognized by the fovea centralis vision. The foveated area 310 may be referred to as a central area.

For example, the peripheral area 320 may indicate an area recognized or gazed by peripheral vision outside a zone (area) gazed by the fovea centralis. For example, the peripheral area 320 may surround the foveated area 310. For example, the peripheral area 320 may indicate a portion of a screen distinguished from the foveated area 310. For example, the peripheral area 320 may indicate a portion of a screen located outside a gaze corresponding to fovea centralis vision. As a non-limiting example, the peripheral area 320 may indicate a portion of a screen spaced apart by a distance longer than a reference distance from a position of the gaze. For example, the peripheral area 320 may indicate a portion of a screen that is included in a field of view of a user viewing the screen but not focused by the user.

For example, the processor 210 may determine a foveated area 310 of a screen displayed on the display 110 operating as the first state and a peripheral area 320 of the screen. For example, the processor 210 may control luminance of the peripheral area 320 to display the peripheral area 320 dimmer than the foveated area 310, while the screen is displayed on the display 110 operating as the first state. For example, the first state may indicate a state of the display 110 that displays the peripheral area 320 dimmer than the foveated area 310 for low power consumption. For example, the first state and the second state are common in terms of a state of the display 110 for low power consumption, but the first state, unlike the second state, may be a state of the display 110 in which it is not recognized by a user that the peripheral area 320 is dimmer than the foveated area 310. For example, a probability that it is recognized by a user that the peripheral area 320 displayed on the display 110 operating as the first state is dimmer than the foveated area 310 displayed on the display 110 operating as the first state may be lower than a probability that it is recognized by a user that a peripheral area (e.g., a peripheral area 420 of FIG. 4) displayed on the display 110 operating as the second state is dimmer than a foveated area (e.g., a foveated area 410 of FIG. 4) displayed on the display 110 operating as the second state.

For example, while the display 110 operates as the first state, the processor 210 may determine a foveated area of a frame image for displaying the screen based on the eye tracking data, and display the foveated area 310 with luminance corresponding to grayscale values of the foveated area of the frame image. For example, while the display 110 operates as the first state, the processor 210 may determine a peripheral area of the frame image based on the eye tracking data, and display the peripheral area 320 with luminance lower than grayscale values of the peripheral area of the frame image to display the peripheral area 320 dimmer than the foveated area 310. For example, the peripheral area 320 may be displayed on the display 110 operating as the first state according to decreasing the grayscale values of the peripheral area of the frame image. As another example, the peripheral area 320 may be displayed on the display 110 operating as the first state, according to providing, to the display panel 232, voltage values each lower than the grayscale values of the peripheral area of the frame image (or current values each lower than the grayscale values of the peripheral area of the frame image) (or voltage values each higher than the grayscale values of the peripheral area of the frame image), by using the display driver circuitry 231. As still another example, the peripheral area 320 may be displayed on the display 110 operating as the first state, according to decreasing the grayscale values of the peripheral area of the frame image and providing, to the display panel 232, voltage values (or current values) each lower than the decreased grayscale values by using the display driver circuitry 231.

For example, the processor 210 may control (or adjust) (or set) the luminance of the peripheral area 320, as tapering (or gradually decreasing) the luminance of the peripheral area 320 from higher luminance near the foveated area 310 to lower luminance at a periphery of the peripheral area 320, while the screen is displayed on the display 110 operating as the first state.

For example, the processor 210 may taper the luminance of the peripheral area 320 from higher luminance near the foveated area 310 to lower luminance at a periphery of the peripheral area 320 in a luminance reduction rate that is determined based on a context, while the screen is displayed on the display 110 operating as the first state.

For example, the context may include a state of a screen displayed on the display 110 operating as the first state. For example, the processor 210 may taper the luminance of the peripheral area 320 from higher luminance near the foveated area 310 to lower luminance at a periphery of the peripheral area 320 in the luminance reduction rate that is determined based on the state of the screen, while the screen is displayed on the display 110 operating as the first state. For example, the processor 210 may control the luminance of the peripheral area 320, as tapering the luminance of the peripheral area 320 in a first luminance reduction rate that is determined based on a first state of the screen, as shown in a state 330. For example, the processor 210 may control the luminance of the peripheral area 320, as tapering the luminance of the peripheral area 320 in a second luminance reduction rate (different from the first luminance reduction rate) that is determined based on a second state of the screen different from the first state of the screen, as shown in a state 340. For example, the peripheral area 320 of the screen displayed on the display 110 operating as the first state may be displayed differently according to the state of the screen.

For example, the state of the screen used to determine the luminance reduction rate applied while the display 110 operates as the first state may include a spatial information value indicating a spatial distribution of brightness values of a foveated area in each of frame images used for a screen to be displayed on the display 110 (e.g., spatial information defined in international telecommunication union telecommunication standardization sector (ITU-T) P.910 standard). For example, the luminance reduction rate may vary according to the spatial information value. For example, the luminance reduction rate may increase as the spatial information value increases. For example, the processor 210 may obtain a spatial information value indicating a spatial distribution of brightness values of foveated area in each of frame images used for a screen to be displayed on the display 110 operating as the first state. For example, the processor 210 may determine, as a first reduction rate, the luminance reduction rate used for tapering the luminance of the peripheral area 320 displayed on the display operating as the first state, based on obtaining a first value as the spatial information value. For example, the processor 210 may determine, as a second reduction rate higher than the first reduction rate, the luminance reduction rate used for tapering the luminance of the peripheral area 320 displayed on the display operating as the first state, based on obtaining a second value higher than the first value as the spatial information value.

For example, the state of the screen used to determine the luminance reduction rate applied while the display 110 operates as the first state may include a temporal information value indicating temporal changes of foveated areas of frame images used for a screen to be displayed on the display 110 (e.g., temporal information defined in ITU-T P.910 standard). For example, the luminance reduction rate may vary according to the temporal information value. For example, the luminance reduction rate may increase as the temporal information value increases. For example, the processor 210 may obtain a temporal information value indicating temporal changes of foveated areas of frame images user for a screen to be displayed on the display 110 operating as the first state. For example, the processor 210 may determine, as a first reduction rate, the luminance reduction rate used for tapering the luminance of the peripheral area 320 displayed on the display 110 operating as the first state, based on obtaining a first value as the temporal information value. For example, the processor 210 may determine, as a second reduction rate higher than the first reduction rate, the luminance reduction rate used for tapering the luminance of the peripheral area 320 displayed on the display 110 operating as the first state, based on obtaining a second value higher than the first value as the temporal information value. As another example, the processor 210 may increase the luminance reduction rate used for tapering the luminance of the peripheral area 320 displayed on the display 110 operating as the first state, based on checking that the temporal information value is changed to be equal to or greater than a threshold value.

For example, the state of the screen used to determine the luminance reduction rate applied while the display 110 operates as the first state may include an average luminance for the screen. For example, the luminance reduction rate may vary according to the average luminance. For example, the processor 210 may obtain an average luminance for the screen based on grayscale values of each of frame images used for the screen to be displayed on the display 110 operating as the first state and at least one brightness value according to settings of the display 110 (e.g., global settings of the wearable device 100). For example, the processor 210 may determine the luminance reduction rate used for tapering the luminance of the peripheral area 320 displayed on the display 110 operating as the first state, based on the average luminance.

For example, the state of the screen used to determine the luminance reduction rate applied while the display 110 operates as the first state may include a relationship between a first average grayscale value of the foveated area 310 and a second average grayscale value of the peripheral area 320. For example, the luminance reduction rate may vary according to the relationship. For example, the processor 210 may obtain a first average grayscale value of foveated areas of frame images used for the screen to be displayed on the display 110 operating as the first state. For example, the processor 210 may obtain a second average grayscale value of peripheral areas of frame images used for the screen to be displayed on the display 110 operating as the first state. For example, the processor 210 may determine, as a first reduction rate, the luminance reduction rate used for tapering the luminance of the peripheral area 320 displayed on the display 110 operating as the first state, based on the first average grayscale value higher than the second average grayscale value. For example, the processor 210 may determine, as a second reduction rate higher than the first reduction rate, the luminance reduction rate used for tapering the luminance of the peripheral area 320 displayed on the display 110 operating as the first state, based on the first average grayscale value lower than the second average grayscale value. As a non-limiting example, the processor 210 may determine, as a third reduction rate between the first reduction rate and the second reduction rate (or as the first reduction rate) (or as the second reduction rate), the luminance reduction rate used for tapering the luminance of the peripheral area 320 displayed on the display 110 operating as the first state, based on the first average grayscale value equal to the second average grayscale value.

For example, the state of the screen used to determine the luminance reduction rate applied while the display 110 operates as the first state may include a change in an average grayscale value of the peripheral area 320. For example, the luminance reduction rate may vary according to the change in the average grayscale value of the peripheral area 320. For example, the processor 210 may obtain an average grayscale value of a peripheral area of each of frame images used for the screen to be displayed on the display 110 operating as the first state. For example, the processor 210 may increase the luminance reduction rate used for tapering the luminance of the peripheral area 320 displayed on the display 110 operating as the first state, based on checking a decrease of the average grayscale value. For example, the processor 210 may decrease the luminance reduction rate used for tapering the luminance of the peripheral area 320 displayed on the display 110 operating as the first state, based on checking an increase of the average grayscale value. As a non-limiting example, the processor 210 may maintain the luminance reduction rate used for tapering the luminance of the peripheral area 320 displayed on the display 110 operating as the first state, based on checking maintenance of the average grayscale value.

For example, the context may include a state of a user (e.g., the user 190) viewing a screen displayed on the display 110 operating as the first state. For example, the processor 210 may taper the luminance of the peripheral area 320 from higher luminance near the foveated area 310 to lower luminance at a periphery of the peripheral area 320 in the luminance reduction rate that is determined based on the state of the user, while the screen is displayed on the display 110 operating as the first state. For example, the processor 210 may control the luminance of the peripheral area 320, as tapering the luminance of the peripheral area 320 in a first luminance reduction rate that is determined based on a first state of the user, as shown in the state 330. For example, the processor 210 may control the luminance of the peripheral area 320, as tapering the luminance of the peripheral area 320 in a second luminance reduction rate (different from the first luminance reduction rate) that is determined based on a second state of the user different from the first state of the user, as shown in the state 340. For example, the peripheral area 320 of the screen displayed on the display 110 operating as the first state may be displayed differently according to the state of the user.

For example, the state of the user used to determine the luminance reduction rate applied while the display 110 operates as the first state may include a change in size of pupil of one or more eyes of the user. For example, the luminance reduction rate may vary according to the change of the size of the pupil. For example, while a screen is displayed on the display 110 operating as the first state, the processor 210 may obtain the eye tracking data including data regarding size of the pupil of the one or more eyes of the user. For example, the processor 210 may increase the luminance reduction rate used for tapering the luminance of the peripheral area 320 displayed on the display 110 operating as the first state, based on checking an increase of the size of the pupil through the eye tracking data. For example, the processor 210 may decrease the luminance reduction rate used for tapering the luminance of the peripheral area 320 displayed on the display 110 operating as the first state, based on checking a decrease of the size of the pupil through the eye tracking data. As a non-limiting example, the processor 210 may maintain the luminance reduction rate used for tapering the luminance of the peripheral area 320 displayed on the display 110 operating as the first state, based on checking maintenance of the size of the pupil through the eye tracking data through the eye tracking data.

For example, the context may include a time during which the first state of the display 110 is maintained. For example, the processor 210 may taper the luminance of the peripheral area 320 from higher luminance near the foveated area 310 to lower luminance at a periphery of the peripheral area 320 in the luminance reduction rate that is determined based at least in part on the time during which the first state of the display 110 is maintained. For example, the processor 210 may control the luminance of the peripheral area 320, as tapering the luminance of the peripheral area 320 in a first luminance reduction rate that is determined based on a first length of the time, as shown in the state 330. For example, the processor 210 may control the luminance of the peripheral area 320, as tapering the luminance of the peripheral area 320 in a second luminance reduction rate (e.g., the second luminance reduction rate higher than the first luminance reduction rate) that is determined based on a second length of the time different from the first length (e.g., the second length longer than the first length), as shown in the state 340.

For example, the processor 210 may increase the luminance reduction rate used for t-apering the luminance of the peripheral area 320 displayed on the display 110, in accordance with elapse of time during which the first state of the display 110 is maintained.

For example, the processor 210 may gradually increase the luminance reduction rate used for tapering the luminance of the peripheral area 320 displayed on the display 110, in accordance with elapse of time during which the first state of the display 110 is maintained, in response to checking that a reference time has elapsed since entering the first state of the display 110.

Referring to FIG. 4, the processor 210 may determine a foveated area 410 of a screen and a peripheral area 420 of the screen to control luminance of the display 110 operating as the second state.

For example, the foveated area 410 may indicate an area recognized or gazed by fovea centralis vision. For example, the foveated area 410 may be determined based on eye tracking data regarding gaze of one or more eyes of a user (e.g., the user 190) wearing the wearable device 100. For example, the foveated area 410 may indicate a portion of a screen in which the gaze corresponding to the fovea centralis vision is located. For example, the foveated area 410 may indicate a portion of a screen focused by a user viewing the screen. For example, the foveated area 410 may be circular as illustrated in FIG. 4. For example, the foveated area 410 may be rectangular or triangular, unlike the illustration of FIG. 4. However, it is not limited thereto. For example, the foveated area 410 may have a shape corresponding to a shape of an area recognized by the fovea centralis vision. The foveated area 410 may be referred to as a central area. As a non-limiting example, a size of the foveated area 410 may be substantially identical to a size of the foveated area 310. As a non-limiting example, the size of the foveated area 410 may be smaller than the size of the foveated area 310. For example, the foveated area 410 may be narrower than the foveated area 310. As a non-limiting example, a shape of the foveated area 410 may be substantially identical to a shape of the foveated area 310. As a non-limiting example, the shape of the foveated area 410 may be different from the shape of the foveated area 310.

For example, the peripheral area 420 may indicate an area recognized or gazed by peripheral vision outside a zone (area) gazed by the fovea centralis. For example, the peripheral area 420 may surround the foveated area 410. For example, the peripheral area 420 may indicate a portion of a screen distinguished from the foveated area 410. For example, the peripheral area 420 may indicate a portion of a screen located outside a gaze corresponding to fovea centralis vision. As a non-limiting example, the peripheral area 420 may indicate a portion of a screen spaced apart by a distance longer than a reference distance from a position of the gaze. For example, the peripheral area 420 may indicate a portion of a screen that is included in a field of view of a user viewing the screen but not focused by the user.

For example, the processor 210 may determine a foveated area 410 of a screen displayed on the display 110 operating as the second state and a peripheral area 420 of the screen. For example, the processor 210 may control luminance of the peripheral area 420 to display the peripheral area 420 dimmer than the foveated area 410 while the screen is displayed on the display 110 operating as the second state. For example, the second state may indicate a state of the display 110 that displays the peripheral area 420 dimmer than the foveated area 410 for lower power consumption and consumes (generally) lower power than the first state. For example, the first state and the second state are common in terms of a state of the display 110 for lower power consumption, but the second state, unlike the first state, may be a state of the display 110 in which it is recognized by a user that the peripheral area 420 is dimmer than the foveated area 410. For example, the second state may indicate a state of the display 110 focused on lower power consumption than higher visual quality. For example, visual quality provided from the display 110 operating as the second state may be lower than visual quality provided from the display 110 operating as the first state, but power consumed by the display 110 operating as the second state may be (generally) lower than power consumed by the display 110 operating as the first state. For example, the second state may indicate a state of the display 110 that displays the peripheral area 420 with luminance at a level at which a user does not feel discomfort. For example, a probability that it is recognized by a user that the peripheral area 420 displayed on the display 110 operating as the second state is dimmer than the foveated area 410 displayed on the display 110 operating as the second state may be higher than a probability that it is recognized by a user that the peripheral area 420 displayed on the display 110 operating as the first state is dimmer than the foveated area 410 displayed on the display 110 operating as the first state.

For example, while the display 110 operates as the second state, the processor 210 may determine a foveated area of a frame image for displaying the screen based on the eye tracking data, and display the foveated area 410 with luminance corresponding to grayscale values of the foveated area of the frame image. For example, while the display 110 operates as the second state, the processor 210 may determine a peripheral area of the frame image based on the eye tracking data, and display the peripheral area 420 with luminance lower than grayscale values of the peripheral area of the frame image to display the peripheral area 420 dimmer than the foveated area 410. For example, the peripheral area 420 may be displayed on the display 110 operating as the second state according to decreasing the grayscale values of the peripheral area of the frame image. As another example, the peripheral area 420 may be displayed on the display 110 operating as the second state, according to providing, to the display panel 232, voltage values (or current values) each lower than the grayscale values of the peripheral area of the frame image by using the display driver circuitry 231. As still another example, the peripheral area 420 may be displayed on the display 110 operating as the second state, according to decreasing the grayscale values of the peripheral area of the frame image and providing, to the display panel 232, voltage values (or current values) each lower than the decreased grayscale values by using the display driver circuitry 231.

For example, the processor 210 may control (or adjust) (or set) the luminance of the peripheral area 420, as tapering (or gradually decreasing) the luminance of the peripheral area 420 from higher luminance near the foveated area 410 to lower luminance at a periphery of the peripheral area 420, while a screen is displayed on the display 110 operating as the second state.

For example, the processor 210 may taper the luminance of the peripheral area 420 from higher luminance near the foveated area 410 to lower luminance at a periphery of the peripheral area 420 in a predetermined luminance reduction rate, while the screen is displayed on the display 110 operating as the second state. For example, the predetermined luminance reduction rate may be maintained independently of (or regardless of) a change of a state of the screen. For example, the predetermined luminance reduction rate may be maintained independently of (or regardless of) a change of a state of a user wearing the wearable device 100.

As a non-limiting example, the predetermined luminance reduction rate may be maintained regardless of a change of a state of a screen and/or a change of a state of a user, but the predetermined luminance reduction rate may be selected, determined, identified, or obtained as one candidate reduction rate among a plurality of candidate reduction rates in reference data stored in the memory 220.

For example, the candidate reduction rate selected as the predetermined luminance reduction rate among the plurality of candidate reduction rates may correspond to a level of the rechargeable battery of the wearable device 100. For example, each of the plurality of candidate reduction rates may be linked to a range of the level of the rechargeable battery in the reference data. For example, the processor 210 may determine, as a first candidate reduction rate among the plurality of candidate reduction rates, the predetermined luminance reduction rate used for tapering the peripheral area 420 displayed on the display 110 operating as the second state, based on checking that a level of the rechargeable battery is within a first range. For example, the processor 210 may control the luminance of the peripheral area 420, as tapering the luminance of the peripheral area 420 in the predetermined luminance reduction rate determined as the first candidate reduction rate, according to the level within the first range, as shown in a state 430. For example, the processor 210 may determine, as a second candidate reduction rate among the plurality of candidate reduction rates, the predetermined luminance reduction rate used for tapering the peripheral area 420 displayed on the display 110 operating as the second state, based on checking that a level of the rechargeable battery is within a second range not overlapping the first range. For example, the processor 210 may control the luminance of the peripheral area 420, as tapering the luminance of the peripheral area 420 in the predetermined luminance reduction rate determined as the second candidate reduction rate, according to the level within the second range, as shown in a state 440.

Referring to FIG. 5, the processor 210 may disable displaying a peripheral area 520 dimmer than a foveated area 510 for the display 110 operating as the third state. For example, the processor 210 may not execute determining (or obtaining) a foveated area 510 of a screen and a peripheral area 520 of the screen to control luminance provided from the display 110 operating as the third state. For example, determining the foveated area 510 and the peripheral area 520 for control of luminance may be bypassed, skipped, blocked, or refrained while the display 110 operates as the third state. As a non-limiting example, determining the foveated area 510 and the peripheral area 520 while the display 110 operates as the third state may be disabled for control of luminance but may also be enabled for control of resolution.

For example, as illustrated in FIG. 5, the processor 210 may set luminance of the screen as luminance corresponding to grayscale values of a frame image for displaying the screen while the display 110 operates as the third state.

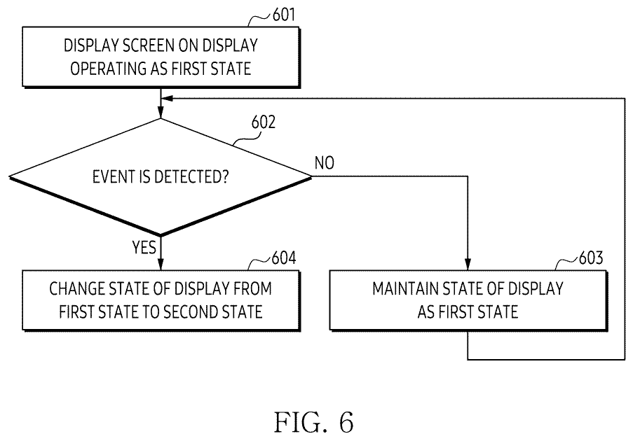

Referring back to FIG. 2, the processor 210 may change a state of the display 110 from a state among the plurality of states to another state among the plurality of states. For example, the processor 210 may change a state of the display 110 from the first state to the second state. The change from the first state to the second state is exemplified in a description of FIG. 6.

FIG. 6 illustrates a method of changing a state of a display from a first state to a second state according to an embodiment of the disclosure.

Referring to FIG. 6, in operation 601, the processor 210 may display a screen on the display 110 operating as the first state. For example, the processor 210 may display the screen, as shown in the state 330 or the state 340.

In operation 602, the processor 210 may check, identify, or monitor whether an event is detected while the display 110 operates as the first state for displaying the screen. The event may be defined for changing a state of the display 110 from the first state to the second state. For example, the event may include a change in a level of the rechargeable battery of the wearable device 100. For example, the event may include that a rate at which power is decreased while the display 110 operates as the first state is higher than a reference rate. For example, the event may include that a number of blinks of one or more eyes of a user (e.g., the user 190) is fewer than a reference number. For example, the event may include that a rate of movement of gaze of one or more eyes of a user is lower than a reference rate. For example, the event may include obtaining the spatial information value higher than a threshold value. For example, the event may include obtaining the temporal information value higher than a threshold value.

For example, the processor 210 may execute operation 603 based on not detecting the event, and execute operation 604 based on detecting the event.

In operation 603, the processor 210 may maintain a state of the display 110 as the first state, on a condition that the event is not detected. For example, the processor 210 may maintain the state of the display 110 as the first state until the event is detected.

For example, the processor 210 may maintain the state of the display 110 as the first state, while checking that a level of the rechargeable battery is higher than a reference level. For example, the processor 210 may maintain the state of the display 110 as the first state, while checking that a rate at which power is decreased while the display 110 operates as the first state is lower than the reference rate. For example, the processor 210 may maintain the state of the display 110 as the first state, while checking that a number of blinks of one or more eyes of a user (e.g., the user 190) is more than a reference number. For example, the processor 210 may maintain the state of the display 110 as the first state, while checking that a rate of movement of gaze of one or more eyes of a user (e.g., the user 190) is higher than a reference rate. For example, the processor 210 may maintain the state of the display 110 as the first state, while obtaining the spatial information value lower than a threshold value. For example, the processor 210 may maintain the state of the display 110 as the first state, while obtaining the temporal information value lower than a threshold value.

As a non-limiting example, the processor 210 may adjust a size of the foveated area 310 and a size of the peripheral area 320, while the first state of the display 110 is maintained. For example, the processor 210 may adjust a size of the foveated area 310 and a size of the peripheral area 320, based on a change of a state of the screen displayed on the display 110 operating as the first state. For example, the processor 210 may adjust a size of the foveated area 310 and a size of the peripheral area 320, based on a change of a state of a user (e.g., the user 190) caused while the display 110 operates as the first state. For example, the processor 210 may adjust a size of the foveated area 310 and a size of the peripheral area 320 in accordance with elapse of time during which the first state is maintained.

In operation 604, the processor 210 may change a state of the display 110 from the first state to the second state, in response to the event detected according to operation 602.

For example, the processor 210 may change a state of the display 110 from the first state to the second state, based on checking that a level of the rechargeable battery is lower than the reference level. For example, the processor 210 may change a state of the display 110 from the first state to the second state, based on checking that a rate at which power is decreased while the display 110 operates as the first state is higher than a reference rate. For example, the processor 210 may change a state of the display 110 from the first state to the second state, based on checking that a number of blinks of one or more eyes of a user (e.g., the user 190) is fewer than a reference number. For example, the processor 210 may change a state of the display 110 from the first state to the second state, based on checking that a rate of movement of gaze of one or more eyes of a user (e.g., the user 190) is lower than a reference rate. For example, the processor 210 may change a state of the display 110 from the first state to the second state, based on obtaining the spatial information value higher than a threshold value. For example, the processor 210 may change a state of the display 110 from the first state to the second state, based on obtaining the temporal information value higher than a threshold value. For example, the processor 210 may change a state of the display 110 from the first state to the second state, based on checking that a length of time during which the state of the display 110 is maintained as the first state is longer than a reference length. For example, the processor 210 may change a state of the display 110 from the first state to the second state, based on the user's usage history information of the wearable device 100. However, it is not limited thereto.

For example, the processor 210 may display the screen on the display 110 operating as the second state changed from the first state, as shown in the state 430 or the state 440.

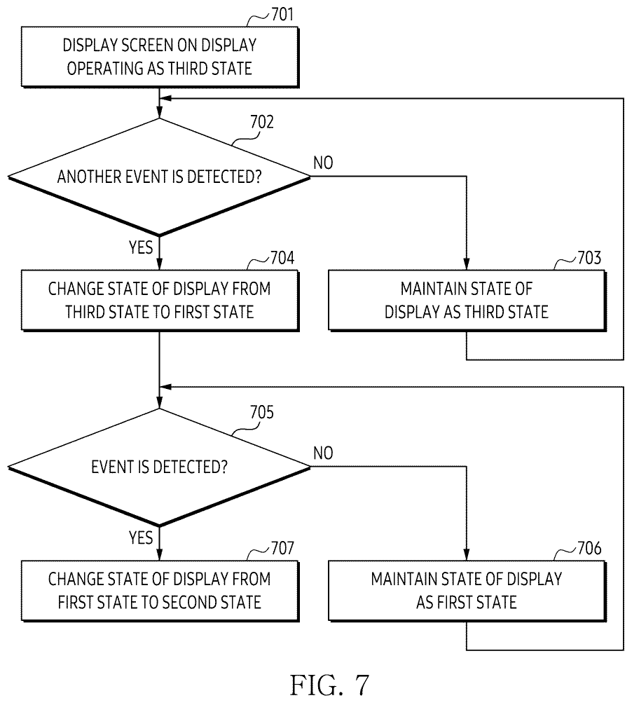

For example, the first state may be changed from the third state. As a non-limiting example, the processor 210 may change a state of the display 110 from the third state to the second state through the first state. Such a change is exemplified in a description of FIG. 7.

FIG. 7 illustrates a method of changing a first state changed from a third state to a second state according to an embodiment of the disclosure.

Referring to FIG. 7, in operation 701, a screen may be displayed on the display 110 operating as the third state. For example, the processor 210 may display the screen, as shown in FIG. 5.

In operation 702, the processor 210 may check, identify, or monitor whether another event is detected while the display 110 operates as the third state for the display of the screen. The other event may be defined for changing a state of the display 110 from the third state to the first state. For example, the other event may include a change in a level of the rechargeable battery of the wearable device 100. For example, the other event may include that a rate at which power is decreased while the display 110 operates as the first state is higher than another reference rate. For example, the other event may include that a number of blinks of one or more eyes of a user (e.g., the user 190) is fewer than another reference number. For example, the other event may include that a rate of movement of gaze of one or more eyes of a user is lower than another reference rate. For example, the other event may include obtaining the spatial information value higher than another threshold value. For example, the other event may include obtaining the temporal information value higher than another threshold value. For example, the other event may include that a length of time during which displaying a screen on the display 110 operating as the third state is maintained reaches a reference length.

For example, the processor 210 may execute operation 703 based on not detecting the other event, and may execute operation 704 based on detecting the other event.

In operation 703, the processor 210 may maintain a state of the display 110 as the third state, on a condition that the other event is not detected. For example, the processor 210 may maintain the state of the display 110 as the third state until the other event is detected.

For example, the processor 210 may maintain the state of the display 110 as the third state, while checking that a level of the rechargeable battery is higher than another reference level (higher than the reference level exemplified for a level of the rechargeable battery in the description of FIG. 6). For example, the processor 210 may maintain the state of the display 110 as the third state, while checking that a rate at which power is decreased while the display 110 operates as the third state is lower than another reference rate (lower than the reference rate exemplified for a rate at which power is decreased in the description of FIG. 6). For example, the processor 210 may maintain the state of the display 110 as the third state, while checking that a number of blinks of one or more eyes of a user (e.g., the user 190) is more than another reference number (more than the reference number exemplified for a number of blinks in the description of FIG. 6). For example, the processor 210 may maintain the state of the display 110 as the third state, while checking that a rate of movement of gaze of one or more eyes of a user (e.g., the user 190) is higher than another reference rate (higher than the reference rate exemplified for a rate of movement of gaze in the description of FIG. 6). For example, the processor 210 may maintain the state of the display 110 as the third state, while obtaining the spatial information value lower than another threshold value (lower than the threshold value exemplified for a spatial information value in the description of FIG. 6). For example, the processor 210 may maintain the state of the display 110 as the third state, while obtaining the temporal information value lower than another threshold value (lower than the threshold value exemplified for a temporal information value in the description of FIG. 6).

In operation 704, the processor 210 may change a state of the display 110 from the third state to the first state, in response to the event detected according to operation 702.

For example, the processor 210 may change a state of the display 110 from the third state to the first state, based on checking that a level of the rechargeable battery is lower than the other reference level (higher than the reference level exemplified for a level of the rechargeable battery in the description of FIG. 6). For example, the processor 210 may change a state of the display 110 from the third state to the first state, based on checking that a rate at which power is decreased while the display 110 operates as the third state is higher than another reference rate (lower than the reference rate exemplified for a rate at which power is decreased in the description of FIG. 6). For example, the processor 210 may change a state of the display 110 from the third state to the first state, based on checking that a number of blinks of one or more eyes of a user (e.g., the user 190) is fewer than another reference number (more than the reference number exemplified for a number of blinks in the description of FIG. 6). For example, the processor 210 may change a state of the display 110 from the third state to the first state, based on checking that a rate of movement of gaze of one or more eyes of a user (e.g., the user 190) is lower than another reference rate (higher than the reference rate exemplified for a rate of movement of the gaze in the description of FIG. 6). For example, the processor 210 may change a state of the display 110 from the third state to the first state, based on obtaining the spatial information value higher than another threshold value (lower than the threshold value exemplified for a spatial information value in the description of FIG. 6). For example, the processor 210 may change a state of the display 110 from the third state to the first state, based on obtaining the temporal information value higher than another threshold value (lower than the threshold value exemplified for a temporal information value in the description of FIG. 6). For example, the processor 210 may change a state of the display 110 from the third state to the first state, based on checking that a length of time during which the state of the display 110 is maintained as the third state is longer than a reference length. For example, the processor 210 may change a state of the display 110 from the third state to the first state, based on user's usage history information of the wearable device 100. However, it is not limited thereto.

For example, the processor 210 may display the screen on the display 110 operating as the first state changed from the third state, as shown in the state 330 or the state 340. For example, operation 704 may partially correspond to operation 601 of FIG. 6.

In operation 705, the processor 210 may check whether an event exemplified in the description of FIG. 6 is detected, while the display 110 operates as the first state. For example, operation 705 may correspond to operation 602 of FIG. 6.

In operation 706, the processor 210 may maintain the state of the display 110 as the first state, while the event does not occur. For example, operation 706 may correspond to operation 603 of FIG. 6.

In operation 707, the processor 210 may change the state of the display 110 from the first state to the second state, in response to occurrence of the event. For example, operation 707 may correspond to operation 604 of FIG. 6.

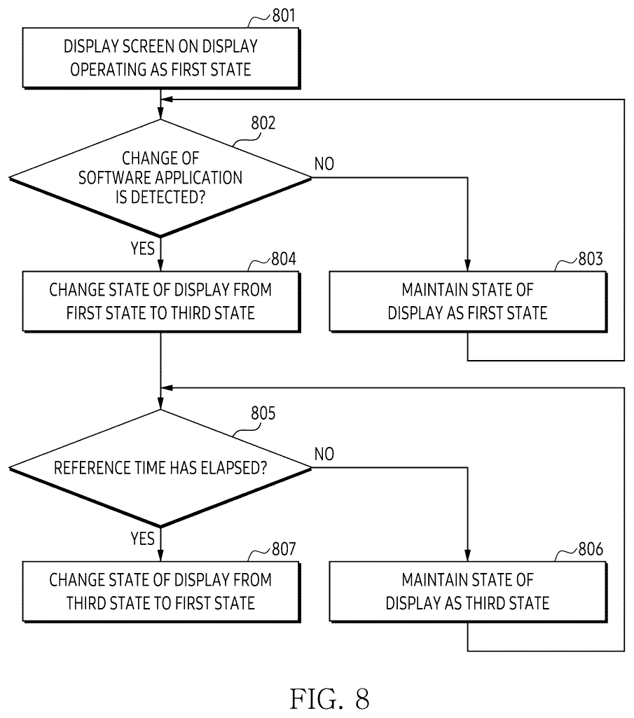

Referring back to FIG. 2, the processor 210 may change a state of the display 110 from the first state to the third state, according to a state of execution of a software application. The change from the first state to the third state is exemplified in a description of FIG. 8.

FIG. 8 illustrates a method of changing a state of a display from a first state to a third state, in response to a change of a software application providing frame images used for displaying a screen according to an embodiment of the disclosure.

Referring to FIG. 8, in operation 801, the processor 210 may display a screen on the display 110 operating as the first state. For example, operation 801 may correspond to operation 601 of FIG. 6.

In operation 802, the processor 210 may check whether a change of a software application providing frame images used for displaying a screen is detected, while the display 110 operates as the first state. For example, since the change of the software application may cause a sudden change (or switch) of a screen displayed on the display 110, the processor 210 may check whether the change of the software application is detected, while the display 110 operates as the first state.

For example, the processor 210 may execute operation 803 on a condition in which the change of the software application is not detected, and may execute operation 804 on a condition in which the change of the software application is detected.

In operation 803, the processor 210 may maintain a state of the display 110 as the first state, while the software application is not changed. Although not illustrated in FIG. 8, the processor 210 may execute operations 602 and 603 of FIG. 6, while the software application is not changed.

In operation 804, the processor 210 may change a state of the display 110 from the first state to the third state, in response to the change of the software application.

As described above, the change of the software application may cause a sudden change of a screen displayed on the display 110. As a non-limiting example, since displaying the screen in which the sudden change is caused on the display 110 operating as the first state may cause a decrease of visual quality, the processor 210 may change a state of the display 110 from the first state to the third state in response to the change of the software application.

For example, the wearable device 100 may maintain visual quality of a screen by displaying the screen on the display 110 operating as the third state changed from the first state.

In operation 805, the processor 210 may check, determine, identify, or monitor whether a reference time has elapsed since the first state is changed to the third state in response to the change of the software application. The processor 210 may execute operation 807 on a condition checking that the reference time has elapsed, and otherwise execute operation 806.

In operation 806, the processor 210 may maintain a state of the display 110 as the third state, while the reference time has not elapsed. As a non-limiting example, although not illustrated in FIG. 8, the processor 210 may also execute operations 702 and 703 of FIG. 7 while the reference time has not elapsed.

In operation 807, the processor 210 may change a state of the display 110 from the third state to the first state, based on checking that the reference time has elapsed. For example, since the fact that the reference time has elapsed since the software application is changed may indicate that the change from the third state to the first state is unnoticeable to a user, the processor 210 may change a state of the display 110 from the third state to the first state for lower power consumption. For example, the processor 210 may display a screen on the display 110 operating as the first state.

Referring back to FIG. 2, as a non-limiting example, the wearable device 100 may not include the eye tracking circuitry 240, or the eye tracking circuitry 240 in the wearable device 100 may be disabled. For example, in a case that the eye tracking circuitry 240 is unavailable, the processor 210 may determine a foveated area of a screen and a peripheral area of the screen without use of the eye tracking data, to control luminance while displaying a screen on the display 110 operating as the first state or the second state. For example, the processor 210 may determine the foveated area and the peripheral area, based on obtaining information regarding the foveated area of the screen from a software application providing frame images for displaying a screen. As another example, the processor 210 may determine the foveated area and the peripheral area, based on information regarding a reference viewing angle configured in the wearable device 100. As still another example, the processor 210 may determine the foveated area and the peripheral area, based on information obtained based on past usage history of the eye tracking circuitry 240. As still another example, the processor 210 may determine the foveated area and the peripheral area, based on information regarding a viewing angle set according to user input. As still another example, the processor 210 may determine the foveated area and the peripheral area, based on information regarding a region of interest (ROI) obtained using a trained model. As a non-limiting example, the model may be trained using fast regions with convolutional neural networks (R-CNN).

The operations exemplified through the above descriptions may be executed not only by a wearable device (e.g., the wearable device 100) but also by an electronic device. For example, the electronic device may be one of a laptop, smartphones having various form factors (e.g., a bar-type smartphone, a foldable-type smartphone, a multi-foldable-type smartphone, or a rollable-type smartphone), a tablet, a television (TV), and other similar computing devices.

The operations exemplified through the above descriptions may be executed by an electronic device exemplified through the description below.

FIG. 9 is a block diagram illustrating an electronic device in a network environment according to an embodiment of the disclosure.

Referring to FIG. 9, an electronic device 901 in a network environment 900 may communicate with an electronic device 902 via a first network 998 (e.g., a short-range wireless communication network), or at least one of an electronic device 904 or a server 908 via a second network 999 (e.g., a long-range wireless communication network). According to an embodiment, the electronic device 901 may communicate with the electronic device 904 via the server 908. According to an embodiment, the electronic device 901 may include a processor 920, memory 930, an input module 950, a sound output module 955, a display module 960, an audio module 970, a sensor module 976, an interface 977, a connecting terminal 978, a haptic module 979, a camera module 980, a power management module 988, a battery 989, a communication module 990, a subscriber identification module (SIM) 996, or an antenna module 997. In some embodiments, at least one of the components (e.g., the connecting terminal 978) may be omitted from the electronic device 901, or one or more other components may be added in the electronic device 901. In some embodiments, some of the components (e.g., the sensor module 976, the camera module 980, or the antenna module 997) may be implemented as a single component (e.g., the display module 960).

The processor 920 may execute, for example, software (e.g., a program 940) to control at least one other component (e.g., a hardware or software component) of the electronic device 901 coupled with the processor 920, and may perform various data processing or computation. According to an embodiment, as at least part of the data processing or computation, the processor 920 may store a command or data received from another component (e.g., the sensor module 976 or the communication module 990) in volatile memory 932, process the command or the data stored in the volatile memory 932, and store resulting data in non-volatile memory 934. According to an embodiment, the processor 920 may include a main processor 921 (e.g., a central processing unit (CPU) or an application processor (AP)), or an auxiliary processor 923 (e.g., a graphics processing unit (GPU), a neural processing unit (NPU), an image signal processor (ISP), a sensor hub processor, or a communication processor (CP)) that is operable independently from, or in conjunction with, the main processor 921. For example, when the electronic device 901 includes the main processor 921 and the auxiliary processor 923, the auxiliary processor 923 may be adapted to consume less power than the main processor 921, or to be specific to a specified function. The auxiliary processor 923 may be implemented as separate from, or as part of the main processor 921.

The auxiliary processor 923 may control at least some of functions or states related to at least one component (e.g., the display module 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). According to an embodiment, the auxiliary processor 923 (e.g., an image signal processor or a communication processor) may be implemented as part of another component (e.g., the camera module 980 or the communication module 990) functionally related to the auxiliary processor 923. According to an embodiment, the auxiliary processor 923 (e.g., the neural processing unit) may include a hardware structure specified for artificial intelligence model processing. An artificial intelligence model may be generated by machine learning. Such learning may be performed, e.g., by the electronic device 901 where the artificial intelligence is performed or via a separate server (e.g., the server 908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934.

The program 940 may be stored in the memory 930 as software, and may include, for example, an operating system (OS) 942, middleware 944, or an application 946.

The input module 950 may receive a command or data to be used by another component (e.g., the processor 920) of the electronic device 901, from the outside (e.g., a user) of the electronic device 901. The input module 950 may include, for example, a microphone, a mouse, a keyboard, a key (e.g., a button), or a digital pen (e.g., a stylus pen).

The sound output module 955 may output sound signals to the outside of the electronic device 901. The sound output module 955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 960 may visually provide information to the outside (e.g., a user) of the electronic device 901. The display module 960 may include, for example, a display, a hologram device, or a projector and control circuitry to control a corresponding one of the display, hologram device, and projector. According to an embodiment, the display module 960 may include a touch sensor adapted to detect a touch, or a pressure sensor adapted to measure the intensity of force incurred by the touch.

The audio module 970 may convert a sound into an electrical signal and vice versa. According to an embodiment, the audio module 970 may obtain the sound via the input module 950, or output the sound via the sound output module 955 or a headphone of an external electronic device (e.g., an electronic device 902) directly (e.g., wiredly) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. According to an embodiment, the sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device (e.g., the electronic device 902) directly (e.g., wiredly) or wirelessly. According to an embodiment, the interface 977 may include, for example, a high definition multimedia interface (HDMI), a universal serial bus (USB) interface, a secure digital (SD) card interface, or an audio interface.

A connecting terminal 978 may include a connector via which the electronic device 901 may be physically connected with the external electronic device (e.g., the electronic device 902). According to an embodiment, the connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or electrical stimulus which may be recognized by a user via his tactile sensation or kinesthetic sensation. According to an embodiment, the haptic module 979 may include, for example, a motor, a piezoelectric element, or an electric stimulator.

The camera module 980 may capture a still image or moving images. According to an embodiment, the camera module 980 may include one or more lenses, image sensors, image signal processors, or flashes.

The power management module 988 may manage power supplied to the electronic device 901. According to an embodiment, the power management module 988 may be implemented as at least part of, for example, a power management integrated circuit (PMIC).

The battery 989 may supply power to at least one component of the electronic device 901. According to an embodiment, the battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the application processor (AP)) and supports a direct (e.g., wired) communication or a wireless communication. According to an embodiment, the communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as Bluetooth™, wireless-fidelity (Wi-Fi) direct, or infrared data association (IrDA)) or the second network 999 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The wireless communication module 992 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 992 may support a high-frequency band (e.g., the millimeter wave (mmWave) band) to achieve, e.g., a high data transmission rate. The wireless communication module 992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 992 may support various requirements specified in the electronic device 901, an external electronic device (e.g., the electronic device 904), or a network system (e.g., the second network 999). According to an embodiment, the wireless communication module 992 may support a peak data rate (e.g., 20 Gbps or more) for implementing eMBB, loss coverage (e.g., 964 dB or less) for implementing mMTC, or user plane (U-plane) latency (e.g., 0.5 ms or less for each of downlink (DL) and uplink (UL), or a round trip of 9 ms or less) for implementing URLLC.

The antenna module 997 may transmit or receive a signal or power to or from the outside (e.g., the external electronic device) of the electronic device 901. According to an embodiment, the antenna module 997 may include an antenna including a radiating element composed of a conductive material or a conductive pattern formed in or on a substrate (e.g., a printed circuit board (PCB)). According to an embodiment, the antenna module 997 may include a plurality of antennas (e.g., array antennas). In such a case, at least one antenna appropriate for a communication scheme used in the communication network, such as the first network 998 or the second network 999, may be selected, for example, by the communication module 990 (e.g., the wireless communication module 992) from the plurality of antennas. The signal or the power may then be transmitted or received between the communication module 990 and the external electronic device via the selected at least one antenna. According to an embodiment, another component (e.g., a radio frequency integrated circuit (RFIC)) other than the radiating element may be additionally formed as part of the antenna module 997.

According to various embodiments, the antenna module 997 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 901 and the external electronic device 904 via the server 908 coupled with the second network 999. Each of the electronic devices 902 or 904 may be a device of a same type as, or a different type, from the electronic device 901. According to an embodiment, all or some of operations to be executed at the electronic device 901 may be executed at one or more of the external electronic devices 902 or 904 or server 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 901. The electronic device 901 may provide the outcome, with or without further processing of the outcome, as at least part of a reply to the request. To that end, a cloud computing, distributed computing, mobile edge computing (MEC), or client-server computing technology may be used, for example. The electronic device 901 may provide ultra low-latency services using, e.g., distributed computing or mobile edge computing. In another embodiment, the external electronic device 904 may include an internet-of-things (IoT) device. The server 908 may be an intelligent server using machine learning and/or a neural network. According to an embodiment, the external electronic device 904 or the server 908 may be included in the second network 999. The electronic device 901 may be applied to intelligent services (e.g., smart home, smart city, smart car, or healthcare) based on 5G communication technology or IoT-related technology.

FIG. 10 is a block diagram illustrating the display module according to an embodiment of the disclosure.

Referring to FIG. 10, a block diagram 1000 illustrates the display module 960 may include a display 1010 and a display driver integrated circuit (DDI) 1030 to control the display 1010. The DDI 1030 may include an interface module 1031, memory 1033 (e.g., buffer memory), an image processing module 1035, or a mapping module 1037. The DDI 1030 may receive image information that contains image data or an image control signal corresponding to a command to control the image data from another component of the electronic device 901 via the interface module 1031. For example, according to an embodiment, the image information may be received from the processor 920 (e.g., the main processor 921 (e.g., an application processor)) or the auxiliary processor 923 (e.g., a graphics processing unit) operated independently from the function of the main processor 921. The DDI 1030 may communicate, for example, with touch circuitry 1050 or the sensor module 976 via the interface module 1031. The DDI 1030 may also store at least part of the received image information in the memory 1033, for example, on a frame-by-frame basis. The image processing module 1035 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 1010. The mapping module 1037 may generate a voltage value or a current value corresponding to the image data pre-processed or post-processed by the image processing module 1035. According to an embodiment, the generating of the voltage value or current value may be performed, for example, based at least in part on one or more attributes of the pixels (e.g., an array, such as a red, green, and blue (RGB) stripe or a pentile structure, of the pixels, or the size of each subpixel). At least some pixels of the display 1010 may be driven, for example, based at least in part on the voltage value or the current value such that visual information (e.g., a text, an image, or an icon) corresponding to the image data may be displayed via the display 1010.

According to an embodiment, the display module 960 may further include the touch circuitry 1050. The touch circuitry 1050 may include a touch sensor 1051 and a touch sensor IC 1053 to control the touch sensor 1051. The touch sensor IC 1053 may control the touch sensor 1051 to sense a touch input or a hovering input with respect to a certain position on the display 1010. To achieve this, for example, the touch sensor 1051 may detect (e.g., measure) a change in a signal (e.g., a voltage, a quantity of light, a resistance, or a quantity of one or more electric charges) corresponding to the certain position on the display 1010. The touch circuitry 1050 may provide input information (e.g., a position, an area, a pressure, or a time) indicative of the touch input or the hovering input detected via the touch sensor 1051 to the processor 920. According to an embodiment, at least part (e.g., the touch sensor IC 1053) of the touch circuitry 1050 may be formed as part of the display 1010 or the DDI 1030, or as part of another component (e.g., the auxiliary processor 923) disposed outside the display module 960.

According to an embodiment, the display module 960 may further include at least one sensor (e.g., a fingerprint sensor, an iris sensor, a pressure sensor, or an illuminance sensor) of the sensor module 976 or a control circuit for the at least one sensor. In such a case, the at least one sensor or the control circuit for the at least one sensor may be embedded in one portion of a component (e.g., the display 1010, the DDI 1030, or the touch circuitry 1050)) of the display module 960. For example, when the sensor module 976 embedded in the display module 960 includes a biometric sensor (e.g., a fingerprint sensor), the biometric sensor may obtain biometric information (e.g., a fingerprint image) corresponding to a touch input received via a portion of the display 1010. As another example, when the sensor module 976 embedded in the display module 960 includes a pressure sensor, the pressure sensor may obtain pressure information corresponding to a touch input received via a partial or whole area of the display 1010. According to an embodiment, the touch sensor 1051 or the sensor module 976 may be disposed between pixels in a pixel layer of the display 1010, or over or under the pixel layer.

As described above, a wearable device (e.g., the wearable device 100) may comprise eye tracking circuitry (e.g., the eye tracking circuitry 240) configured to obtain eye tracking data regarding gaze of one or more eyes, a display (e.g., the display 110), and a processor (e.g., the processor 210). The processor may be configured to determine, based on the eye tracking data, a foveated area of a screen displayed on the display and a peripheral area of the screen that surrounds the foveated area; while the screen is displayed on the display operating as a first state, control luminance of the peripheral area to display the peripheral area dimmer than the foveated area; and while the screen is displayed on the display operating as a second state for lower power consumption than the first state, control luminance of the peripheral area to display the peripheral area dimmer than the peripheral area displayed on the display operating as the first state.

For example, the wearable device may comprise a rechargeable battery. For example, the processor may be configured to check a level of the rechargeable battery; maintain, while checking the level higher than a reference level, a state of the display as the first state; and change, based on checking the level lower than the reference level, the state of the display from the first state to the second state.

For example, the processor may be configured to check a rate at which power is reduced while the display operates as the first state; maintain, while checking the rate lower than a reference rate, a state of the display as the first state; and change, based on checking the rate higher than the reference rate, the state of the display from the first state to the second state.

For example, the eye tracking data may include data regarding a number of blinks of the one or more eyes. For example, the processor may be configured to maintain, while checking the number more than a reference number, a state of the display as the first state; and change, based on checking the number fewer than the reference number, the state of the display from the first state to the second state.

For example, the eye tracking data may include data regarding a rate of movement of the gaze. For example, the processor may be configured to maintain, while checking the rate higher than a reference rate, a state of the display as the first state; and change, based on checking the rate lower than the reference rate, the state of the display from the first state to the second state.

For example, the processor may be configured to obtain a spatial information value indicating spatial distribution of brightness values of a foveated area in each of frame images used for the screen to be displayed in the first state; maintain, while obtaining the spatial information value lower than a threshold value, a state of the display as the first state; and change, based on obtaining the spatial information value higher than the threshold value, the state of the display from the first state to the second state.

For example, the processor may be configured to obtain a temporal information value indicating temporal changes of foveated areas of frame images used for the screen to be displayed in the first state; maintain, while obtaining the temporal information value lower than a threshold value, a state of the display as the first state; and change, based on obtaining the temporal information value higher than the threshold value, the state of the display from the first state to the second state.

For example, the processor may be configured to, while the screen is displayed on the display operating as the first state, control the luminance of the peripheral area, as tapering the luminance of the peripheral area from higher luminance near the foveated area to lower luminance at a periphery of the peripheral area in a luminance reduction rate that is determined based on a state of the screen; and while the screen is displayed on the display operating as the second state, control the luminance of the peripheral area, as tapering the luminance of the peripheral area from higher luminance near the foveated area to lower luminance at a periphery of the peripheral area in a predetermined luminance reduction rate.

For example, the processor may be configured to obtain a spatial information value indicating spatial distribution of brightness values of a foveated area in each of frame images used for the screen to be displayed on the display operating as the first state; determine, as a first reduction rate, the luminance reduction rate used for tapering the luminance of the peripheral area displayed on the display operating as the first state, based on obtaining a first value as the spatial information value; and determine, as a second reduction rate higher than the first reduction rate, the luminance reduction rate used for tapering the luminance of the peripheral area displayed on the display operating as the first state, based on obtaining a second value higher than the first value as the spatial information value.

For example, the processor may be configured to obtain a temporal information value indicating temporal changes foveated areas of frame images used for the screen to be displayed on the display operating as the first state; determine, as a first reduction rate, the luminance reduction rate used for tapering the luminance of the peripheral area displayed on the display operating as the first state, based on obtaining a first value as the temporal information value; and determine, as a second reduction rate higher than the first reduction rate, the luminance reduction rate used for tapering the luminance of the peripheral area displayed on the display operating as the first state, based on obtaining a second value higher than the first value as the temporal information value.

For example, the processor may be configured to obtain average luminance for the screen, based on grayscale values of each of the frame images used for the screen to be displayed on the display operating as the first state and at least one brightness value according to settings of the display; and determine, based on the average luminance, the luminance reduction rate used for tapering the luminance of the peripheral area displayed on the display operating as the first state.

For example, the processor may be configured to obtain a first average grayscale value of a foveated area of each of frame images used for the screen to be displayed on the display operating as the first state; obtain a second average grayscale value of a peripheral area of each of the frame images used for the screen to be displayed on the display operating as the first state; determine, as a first reduction rate, the luminance reduction rate used for tapering the luminance of the peripheral area displayed on the display operating as the first state, based on the first average grayscale value higher than the second average grayscale value; and determine, as a second reduction rate higher than the first reduction rate, the luminance reduction rate used for tapering the luminance of the peripheral area displayed on the display operating as the first state, based on the first average grayscale value lower than the second average grayscale value.

For example, the processor may be configured to obtain an average grayscale value of a peripheral area of each of frame images used for the screen to be displayed on the display operating as the first state; based on checking a decrease in the average grayscale value, increase the luminance reduction rate used for tapering the luminance of the peripheral area displayed on the display operating as the first state; and based on checking an increase in the average grayscale value, decrease the luminance reduction rate used for tapering the luminance of the peripheral area displayed on the display operating as the first state.

For example, the processor may be configured to obtain the eye tracking data including data regarding size of pupil of the one or more eyes, while the screen is displayed on the display operating as the first state; increase, based on checking an increase in the size of the pupil, the luminance reduction rate used for tapering the luminance of the peripheral area displayed on the display operating as the first state; and decrease, based on checking a decrease in the size of the pupil, the luminance reduction rate used for tapering the luminance of the peripheral area displayed on the display operating as the first state.

For example, the processor may be configured to increase, in accordance with elapse of time during which the first state is maintained, the luminance reduction rate used for tapering the luminance of the peripheral area displayed on the display operating as the first state.

For example, the processor may be configured to, in response to checking that a reference time has elapsed since entering the first state, gradually increase the luminance reduction rate used for tapering the luminance of the peripheral area displayed on the display operating as the first state, in accordance with elapse of time during which the first state is maintained.

For example, the predetermined luminance reduction rate used for tapering the luminance of the peripheral area displayed on the display operating as the second state may be maintained independently of a change of the state of the screen.

For example, the processor may be configured to check a level of the rechargeable battery and, while the screen is displayed on the display operating as the second state, determine, as the predetermined luminance reduction rate, a candidate reduction rate corresponding to the level among a plurality of candidate reduction rates in reference data stored in the memory.

For example, the foveated area displayed on the display operating as the first state may be wider than the foveated area displayed on the display operating as the second state.

For example, the processor may be configured to, based on the state of the screen, adjust a size of the foveated area displayed on the display operating as the first state and a size of the peripheral area displayed on the display operating as the first state.

For example, the processor may be configured to adjust the size of the foveated area displayed on the display operating as the first state and the size of the peripheral area displayed on the display operating as the first state, based further on a state of a user wearing the wearable device, while the screen is displayed on the display operating as the first state.

For example, displaying the peripheral area dimmer than the foveated area may be disabled while the display operates as the third state for performance.

For example, the processor may be configured to change a state of the display from the first state to the third state, in response to a change of a software application providing frame images used for displaying the screen, while the screen is displayed on the display operating as the first state.

As described above, a wearable device (e.g., the wearable device 100) may comprise memory (e.g., the memory 220) configured to store instructions, eye tracking circuitry (e.g., the eye tracking circuitry 240) configured to obtain eye tracking data regarding gaze of one or more eyes, a display (e.g., the display 110), and a processor (e.g., the processor 210). The processor may be configured to execute the instructions to cause the wearable device to determine, based on the eye tracking data, a foveated area of a screen displayed on the display and a peripheral area of the screen surrounding the foveated area, display the peripheral area dimmer than the foveated area by tapering luminance of the peripheral area from higher luminance near the foveated area to lower luminance at a periphery of the peripheral area by using a luminance reduction rate determined based on a state of the screen in a first state for lower power consumption of the display, and display the peripheral area dimmer than the foveated area by tapering luminance of the peripheral area from higher luminance near the foveated area to lower luminance at a periphery of the peripheral area by using a predetermined luminance reduction rate in a second state for lower power consumption of the display.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 940) including one or more instructions that are stored in a storage medium (e.g., internal memory 936 or external memory 938) that is readable by a machine (e.g., the electronic device 901). For example, a processor (e.g., the processor 920) of the machine (e.g., the electronic device 901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable device comprising:
memory, comprising one or more storage media, storing instructions;
eye tracking circuitry configured to obtain eye tracking data regarding a gaze of one or more eyes;
a display; and
at least one processor comprising processing circuitry,
wherein the instructions, when executed by the at least one processor individually or collectively, cause the wearable device to:
determine, based on the eye tracking data, a foveated area of a screen displayed on the display and a peripheral area of the screen that surrounds the foveated area,
while the screen is displayed on the display operating as a first state, control a luminance of the peripheral area to display the peripheral area dimmer than the foveated area, and
while the screen is displayed on the display operating as a second state for lower power consumption than the first state, control the luminance of the peripheral area to display the peripheral area dimmer than the peripheral area displayed on the display operating as the first state.

2. The wearable device of claim 1, further comprising:
a rechargeable battery,
wherein the instructions, when executed by the at least one processor individually or collectively, cause the wearable device to:
check a level of the rechargeable battery,
maintain, while checking the level higher than a reference level, a state of the display as the first state, and
change, based on checking the level lower than the reference level, the state of the display from the first state to the second state.

3. The wearable device of claim 1, wherein the instructions, when executed by the at least one processor individually or collectively, cause the wearable device to:
check a rate at which power is reduced while the display operates as the first state;
maintain, while checking the rate lower than a reference rate, a state of the display as the first state; and
change, based on checking the rate higher than the reference rate, the state of the display from the first state to the second state.

4. The wearable device of claim 1,
wherein the eye tracking data includes data regarding a number of blinks of the one or more eyes, and
wherein the instructions, when executed by the at least one processor individually or collectively, further cause the wearable device to:
maintain, while checking the number more than a reference number, a state of the display as the first state, and
change, based on checking the number fewer than the reference number, the state of the display from the first state to the second state.

5. The wearable device of claim 1,
wherein the eye tracking data includes data regarding a rate of movement of the gaze, and
wherein the instructions, when executed by the at least one processor individually or collectively, cause the wearable device to:
maintain, while checking the rate higher than a reference rate, a state of the display as the first state, and
change, based on checking the rate lower than the reference rate, the state of the display from the first state to the second state.

6. The wearable device of claim 1, wherein the instructions, when executed by the at least one processor individually or collectively, cause the wearable device to:
obtain a spatial information value indicating spatial distribution of brightness values of a foveated area in each of frame images used for the screen to be displayed on the display operating as the first state;
maintain, while obtaining the spatial information value lower than a threshold value, a state of the display as the first state; and
change, based on obtaining the spatial information value higher than the threshold value, the state of the display from the first state to the second state.

7. The wearable device of claim 1, wherein the instructions, when executed by the at least one processor individually or collectively, cause the wearable device to:
obtain a temporal information value indicating temporal changes of foveated areas of frame images used for the screen to be displayed on the display operating as the first state;
maintain, while obtaining the temporal information value lower than a threshold value, a state of the display as the first state; and
change, based on obtaining the temporal information value higher than the threshold value, the state of the display from the first state to the second state.

8. The wearable device of claim 1, wherein the instructions, when executed by the at least one processor individually or collectively, cause the wearable device to:
while the screen is displayed on the display operating as the first state, control the luminance of the peripheral area, as tapering the luminance of the peripheral area from higher luminance near the foveated area to lower luminance at a periphery of the peripheral area in a luminance reduction rate that is determined based on a state of the screen; and
while the screen is displayed on the display operating as the second state, control the luminance of the peripheral area, as tapering the luminance of the peripheral area from higher luminance near the foveated area to lower luminance at a periphery of the peripheral area in a predetermined luminance reduction rate.

9. The wearable device of claim 8, wherein the instructions, when executed by the at least one processor individually or collectively, cause the wearable device to:
obtain a spatial information value indicating spatial distribution of brightness values of a foveated area in each of frame images used for the screen to be displayed on the display operating as the first state;
determine, as a first reduction rate, the luminance reduction rate used for tapering the luminance of the peripheral area displayed on the display operating as the first state, based on obtaining a first value as the spatial information value; and
determine, as a second reduction rate higher than the first reduction rate, the luminance reduction rate used for tapering the luminance of the peripheral area displayed on the display operating as the first state, based on obtaining a second value higher than the first value as the spatial information value.

10. The wearable device of claim 8, wherein the instructions, when executed by the at least one processor individually or collectively, cause the wearable device to:
obtain a temporal information value indicating temporal changes foveated areas of frame images used for the screen to be displayed on the display operating as the first state;
determine, as a first reduction rate, the luminance reduction rate used for tapering the luminance of the peripheral area displayed on the display operating as the first state, based on obtaining a first value as the temporal information value; and
determine, as a second reduction rate higher than the first reduction rate, the luminance reduction rate used for tapering the luminance of the peripheral area displayed on the display operating as the first state, based on obtaining a second value higher than the first value as the temporal information value.

11. The wearable device of claim 10, wherein the instructions, when executed by the at least one processor individually or collectively, cause the wearable device to:
obtain average luminance for the screen, based on grayscale values of each of the frame images used for the screen to be displayed on the display operating as the first state and at least one brightness value according to settings of the display; and
determine, based on the average luminance, the luminance reduction rate used for tapering the luminance of the peripheral area displayed on the display operating as the first state.

12. The wearable device of claim 8, wherein the instructions, when executed by the at least one processor individually or collectively, cause the wearable device to:
obtain a first average grayscale value of a foveated area of each of frame images used for the screen to be displayed on the display operating as the first state;
obtain a second average grayscale value of a peripheral area of each of the frame images used for the screen to be displayed on the display operating as the first state;
determine, as a first reduction rate, the luminance reduction rate used for tapering the luminance of the peripheral area displayed on the display operating as the first state, based on the first average grayscale value higher than the second average grayscale value; and
determine, as a second reduction rate higher than the first reduction rate, the luminance reduction rate used for tapering the luminance of the peripheral area displayed on the display operating as the first state, based on the first average grayscale value lower than the second average grayscale value.

13. The wearable device of claim 8, wherein the instructions, when executed by the at least one processor individually or collectively, cause the wearable device to:
obtain an average grayscale value of a peripheral area of each of frame images used for the screen to be displayed on the display operating as the first state;
based on checking a decrease in the average grayscale value, increase the luminance reduction rate used for tapering the luminance of the peripheral area displayed on the display operating as the first state; and
based on checking an increase in the average grayscale value, decrease the luminance reduction rate used for tapering the luminance of the peripheral area displayed on the display operating as the first state.

14. The wearable device of claim 8, wherein the instructions, when executed by the at least one processor individually or collectively, cause the wearable device to:
obtain the eye tracking data including data regarding size of pupil of the one or more eyes, while the screen is displayed on the display operating as the first state;
increase, based on checking an increase in the size of the pupil, the luminance reduction rate used for tapering the luminance of the peripheral area displayed on the display operating as the first state; and
decrease, based on checking a decrease in the size of the pupil, the luminance reduction rate used for tapering the luminance of the peripheral area displayed on the display operating as the first state.

15. The wearable device of claim 8, wherein the instructions, when executed by the at least one processor individually or collectively, cause the wearable device to increase, in accordance with elapse of time during which the first state is maintained, the luminance reduction rate used for tapering the luminance of the peripheral area displayed on the display operating as the first state.

16. The wearable device of claim 8, wherein the instructions, when executed by the at least one processor individually or collectively, cause the wearable device to:
in response to checking that reference time is elapsed since entering the first state, gradually increase, in accordance with elapse of time during which the first state is maintained, the luminance reduction rate used for tapering the luminance of the peripheral area displayed on the display operating as the first state.

17. The wearable device of claim 8, the predetermined luminance reduction rate used for tapering the luminance of the peripheral area displayed on the display operating as the second state is maintained independently of change of the state of the screen.

18. The wearable device of claim 8, further comprising:
a rechargeable battery,
wherein the instructions, when executed by the at least one processor individually or collectively, cause the wearable device to:
check a level of the rechargeable battery, and
while the screen is displayed on the display operating as the second state, determine, as the predetermined luminance reduction rate, a candidate reduction rate corresponding to the level from among a plurality of candidate reduction rates in reference data stored in the memory.

19. The wearable device of claim 1, wherein the foveated area displayed on the display operating as the first state is wider than the foveated area displayed on the display operating as the second state.

20. The wearable device of claim 1, wherein the instructions, when executed by the at least one processor individually or collectively, cause the wearable device to adjust, based on the state of the screen, size of the foveated area displayed on the display operating as the first state and size of the peripheral area displayed on the display operating as the first state.
